(19) United States
(12) Patent Application Publication
(10) Pub. No.: US 2023/0254592 A1
(43) Pub. Date: Aug. 10, 2023

(54) SYSTEM AND METHOD FOR REDUCING TRANSMISSION BANDWIDTH IN EDGE CLOUD SYSTEMS

(71) Applicant: Robert Bosch GmbH, Stuttgart (DE)

(72) Inventors: Jayanta Kumar DUTTA, Sunnyvale, CA (US); Naveen RAMAKRISHNAN, Campbell, CA (US)

(21) Appl. No.: 17/666,525

(22) Filed: Feb. 7, 2022

(51) Int. Cl. H04N 5/232; G06T 3/40; H04N 19/33; G06N 3/08

(52) U.S. Cl. CPC H04N 5/23235; G06T 3/4053; G06T 3/4046; H04N 19/33; G06N 3/08

(57) ABSTRACT

A computer-implemented method includes communicating with a remote network, capturing one or more images or video recordings, receiving one or more images from the camera, wherein the one or more images from the camera is a high resolution image (HRI), compressing the HRI via a compression model to a low resolution image (LRI), encoding the LRI to obtain an encoded LRI, sending the encoded LRI to a super resolution model at the remote network, decoding the encoded LRI at the remote network to obtain a reconstructed HRI, and outputting the reconstructed HRI.

### TECHNICAL FIELD

The present disclosure relates to edge-cloud systems, including that that may transmit data (e.g., images, sound, or video recordings) to a remote network (e.g., “cloud”).

### BACKGROUND

Efficiently transmitting videos at high resolutions with least bandwidth is a consideration in developing networked edge devices that may utilize image and/or video applications. A possible solution is to encode the videos using a newly developed and advanced video coding standard. Reducing bitrate of transmitting the compressed video may also be achieved by increasing the degree of quantization or reducing the resolution, but at the cost of reducing video quality. Traditional deblocking or up-sampling filters (e.g., bicubic) usually smooth the images, causing quality degradation. In addition to aforementioned methods to reduce bitrate of video transmission, recently, deep learning may be utilized to improve the video resolution at reduced transmission bitrates.

### SUMMARY

According to a first embodiment, a system includes a wireless transceiver. The wireless transceiver is configured to communicate with a remote network. The system further includes a camera, wherein the camera is configured to capture images or video recordings. The system also includes a controller, wherein the controller is configured to receive one or more images from the camera, wherein the one or more images from the camera is a high resolution image, downsample the high resolution image (HRI), compress the HRI via a compression model at an edge device, wherein the HRI is compressed to a low resolution image (LRI), encode the LRI and send an encoded LRI to a super resolution model at the remote network, decode the encoded LRI at the remote network to obtain a reconstructed HRI, and output the reconstructed HRI.

According to a second embodiment, an apparatus includes a wireless transceiver, wherein the wireless transceiver is configured to communicate with a remote network. The apparatus also includes a camera, wherein the camera is configured to capture images or video recordings, a controller, wherein the controller is in communication with the wireless transceiver and the camera. The controller is configured to receive one or more images from the camera, wherein the one or more images from the camera is a high resolution image (HRI), compress the HRI via a compression model to a low resolution image (LRI), encode the LRI and send an encoded LRI to a super resolution model at the remote network, wherein the super resolution model utilizes a machine learning network, and send the encoded LRI to a remote network configured to decode the encoded LRI at the remote network to obtain a reconstructed HRI.

According to a third embodiment, a computer-implemented method includes communicating with a remote network, capturing one or more images or video recordings, receiving one or more images from the camera, wherein the one or more images from the camera is a high resolution image (HRI), compressing the HRI via a compression model to a low resolution image (LRI), encoding the LRI to obtain an encoded LRI, sending the encoded LRI to a super resolution model at the remote network, decoding the encoded LRI at the remote network to obtain a reconstructed HRI, and outputting the reconstructed HRI.

### BRIEF DESCRIPTION OF THE DRAWINGS

FIG. 1A illustrates a mobile telephone network and a representation of the internet.

FIG. 1B illustrates components of an exemplary system that can be used to train and utilize machine learning.

FIG. 2 illustrates a typical edge based system with cloud communication.

FIG. 3 illustrates an edge-cloud system diagram utilizing a learned compression and reconstruction

FIG. 4 illustrates an illustrative flow chart of a training phase of the system.

### DETAILED DESCRIPTION

Embodiments of the present disclosure are described herein. It is to be understood, however, that the disclosed embodiments are merely examples and other embodiments can take various and alternative forms. The figures are not necessarily to scale; some features could be exaggerated or minimized to show details of particular components. Therefore, specific structural and functional details disclosed herein are not to be interpreted as limiting, but merely as a representative basis for teaching one skilled in the art to variously employ the embodiments. As those of ordinary skill in the art will understand, various features illustrated and described with reference to any one of the figures can be combined with features illustrated in one or more other figures to produce embodiments that are not explicitly illustrated or described. The combinations of features illustrated provide representative embodiments for typical applications. Various combinations and modifications of the features consistent with the teachings of this disclosure, however, could be desired for particular applications or implementations.

In the disclosure below, an embodiment of the disclosure illustrates a system and a method for compressing image/video data at edge by utilizing information about the super-resolution model at cloud and imposing edge-specific hardware constraints. The disclosure also presents a procedure to jointly learn the compression model and the super-resolution model which may reliably reproduce the original data at cloud with ˜4× reduction in information transmitted.

Most cloud applications, where data originates at the edge, rely on accurate and efficient transmission of information between edge and cloud. Recent progress in sensor technologies have enabled high resolution data capture at edge. However, bandwidth constraints restrict edge devices to resort to lossy compression (e.g., the size of the file is reduced by eliminating data in the file or data) followed by a reconstruction mechanism in cloud. Most traditional edge-cloud systems do not have the knowledge of the reconstruction mechanism while compressing the data at edge. This may lead to inefficient compression at edge or poor reconstruction at cloud. In the case of image and video data generated at edge devices, recent progress in super-resolution methods using Generative Adversarial Networks (GANs) have proven to be useful to reproduce high quality data in cloud using low quality transmissions. Typical ways to reduce transmission bandwidth may be to simply reduce resolution at edge by throwing away information.

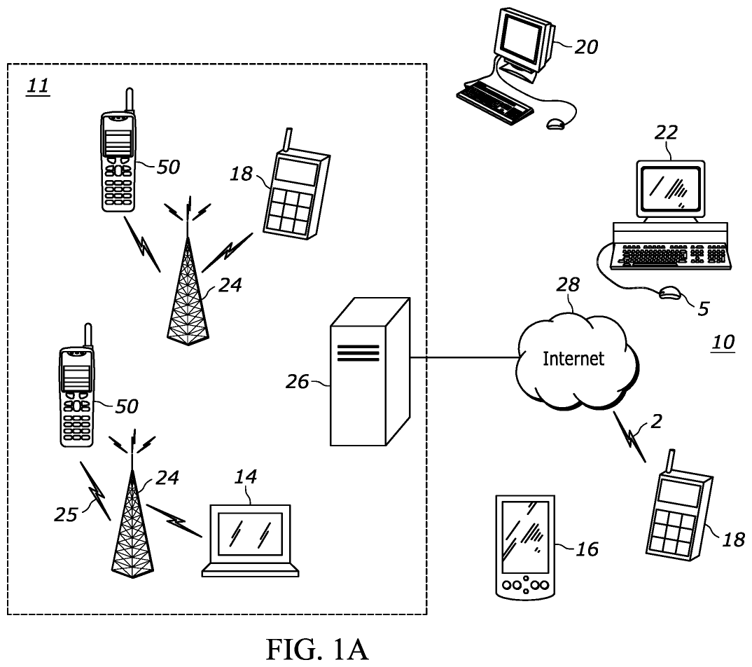

The system shown in FIG. 1A illustrates a mobile telephone network 11 and a representation of the internet 28. Connectivity to the internet 28 may include, but is not limited to, long range wireless connections, short range wireless connections, and various wired connections including, but not limited to, telephone lines, cable lines, power lines, and similar communication pathways.

The example communication devices shown in the system 10 may include, but are not limited to, an electronic device or apparatus 50, a combination of a personal digital assistant (PDA) and a mobile telephone 14, a PDA 16, an integrated messaging device (IMD) 18, a desktop computer 20, a notebook computer 22. The apparatus 50 may be stationary or mobile when carried by an individual who is moving. The apparatus 50 may also be located in a mode of transport including, but not limited to, a car, a truck, a taxi, a bus, a train, a boat, an airplane, a bicycle, a motorcycle or any similar suitable mode of transport.

The embodiments may also be implemented in a set-top box; i.e. a digital TV receiver, which may/may not have a display or wireless capabilities, in tablets or (laptop) personal computers (PC), which have hardware or software or combination of the encoder/decoder implementations, in various operating systems, and in chipsets, processors, DSPs and/or embedded systems offering hardware/software based coding.

Some or further apparatus may send and receive calls and messages and communicate with service providers through a wireless connection 25 to a base station 24. The base station 24 may be connected to a network server 26 that allows communication between the mobile telephone network 11 and the internet 28. The system may include additional communication devices and communication devices of various types.

The communication devices may communicate using various transmission technologies including, but not limited to, code division multiple access (CDMA), global systems for mobile communications (GSM), universal mobile telecommunications system (UMTS), time divisional multiple access (TDMA), frequency division multiple access (FDMA), transmission control protocol-internet protocol (TCP-IP), short messaging service (SMS), multimedia messaging service (MMS), email, instant messaging service (IMS), Bluetooth, IEEE 802.11 and any similar wireless communication technology. A communications device involved in implementing various embodiments of the present invention may communicate using various media including, but not limited to, radio, infrared, laser, cable connections, and any suitable connection.

Real-time Transport Protocol (RTP) is widely used for real-time transport of timed media such as audio and video. RTP may operate on top of the User Datagram Protocol (UDP), which in turn may operate on top of the Internet Protocol (IP). RTP is specified in Internet Engineering Task Force (IETF) Request for Comments (RFC) 3550, available from www.ietforg/rfc/rfc3550.txt. In RTP transport, media data is encapsulated into RTP packets. Typically, each media type or media coding format has a dedicated RTP payload format.

An RTP session is an association among a group of participants communicating with RTP. It is a group communications channel which can potentially carry a number of RTP streams. An RTP stream is a stream of RTP packets comprising media data. An RTP stream is identified by an SSRC belonging to a particular RTP session. SSRC refers to either a synchronization source or a synchronization source identifier that is the 32-bit SSRC field in the RTP packet header. A synchronization source is characterized in that all packets from the synchronization source form part of the same timing and sequence number space, so a receiver may group packets by synchronization source for playback. Examples of synchronization sources include the sender of a stream of packets derived from a signal source such as a microphone or a camera, or an RTP mixer. Each RTP stream is identified by a SSRC that is unique within the RTP session.

FIG. 1B discloses components of an exemplary system that can be used to train and utilize machine learning, for use in implementing some embodiments of the present disclosure. Various components can be provided by various combinations of computing devices and resources, or a single computing system, which may be under control of a single entity or multiple entities. Further, aspects may be triggered, initiated, or requested by different entities. In at least one embodiment training of a neural network might be instructed by a provider associated with provider environment 106, while in at least one embodiment training might be requested by a customer or other user having access to a provider environment through a client device 102 (e.g., edge device) or other such resource. In at least one embodiment, training data (or data to be analyzed by a trained neural network) can be provided by a provider, a user, or a third party content provider 124. In at least one embodiment, client device 102 may be a vehicle or object that is to be navigated on behalf of a user, for example, which can submit requests and/or receive instructions that assist in navigation of a device.

FIG. 1B discloses components of an exemplary system that can be used to train and utilize machine learning, for use in implementing some embodiments of the present disclosure. Components of an exemplary system 155 that can be used to train and utilize machine learning, in accordance with at least one embodiment. As will be discussed, various components can be provided by various combinations of computing devices and resources, or a single computing system, which may be under control of a single entity or multiple entities. Further, aspects may be triggered, initiated, or requested by different entities. In at least one embodiment training of a neural network might be instructed by a provider associated with provider environment 106, while in at least one embodiment training might be requested by a customer or other user having access to a provider environment through a client device 102 or other such resource. In at least one embodiment, training data (or data to be analyzed by a trained neural network) can be provided by a provider, a user, or a third party content provider 124. In at least one embodiment, client device 102 may be a vehicle or object that is to be navigated on behalf of a user, for example, which can submit requests and/or receive instructions that assist in navigation of a device. The client device 102 may also be an edge device and may also have training ability via a neural network similar to that in the provider environment 106.

In at least one embodiment, requests are able to be submitted across at least one network 104 to be received by a provider environment 106. In at least one embodiment, a client device 102 may be any appropriate electronic and/or computing devices enabling a user to generate and send such requests, such as, but not limited to, desktop computers, notebook computers, computer servers, smartphones, tablet computers, gaming consoles (portable or otherwise), computer processors, computing logic, and set-top boxes. Network(s) 104 can include any appropriate network for transmitting a request or other such data, as may include the Internet, an intranet, a cellular network, a local area network (LAN), a wide area network (WAN), a personal area network (PAN), an ad hoc network of direct wireless connections among peers, and so on.

In at least one embodiment, requests can be received at an interface layer 108, which can forward data to a training and inference manager 132, in this example. The training and inference manager 132 can be a system or service including hardware and software for managing requests and service corresponding data or content, in at least one embodiment, the training and inference manager 132 can receive a request to train a neural network, and can provide data for a request to a training module 112. In at least one embodiment, training module 112 can select an appropriate model or neural network to be used, if not specified by the request, and can train a model using relevant training data. In at least one embodiment, training data can be a batch of data stored in a training data repository 114, received from client device 102, or obtained from a third party provider 124. In at least one embodiment, training module 112 can be responsible for training data. A neural network can be any appropriate network, such as a recurrent neural network (RNN) or convolutional neural network (CNN). Once a neural network is trained and successfully evaluated, a trained neural network can be stored in a model repository 116, for example, that may store different models or networks for users, applications, or services, etc. In at least one embodiment, there may be multiple models for a single application or entity, as may be utilized based on a number of different factors.

In at least one embodiment, at a subsequent point in time, a request may be received from client device 102 (or another such device) for content (e.g., path determinations) or data that is at least partially determined or impacted by a trained neural network. This request can include, for example, input data to be processed using a neural network to obtain one or more inferences or other output values, classifications, or predictions, or, for at least one embodiment, input data can be received by interface layer 108 and directed to inference module 118, although a different system or service can be used as well. In at least one embodiment, inference module 118 can obtain an appropriate trained network, such as a trained deep neural network (DNN) as discussed herein, from model repository 116 if not already stored locally to inference module 118. Inference module 118 can provide data as input to a trained network, which can then generate one or more inferences as output. This may include, for example, a classification of an instance of input data. In at least one embodiment, inferences can then be transmitted to client device 102 for display or other communication to a user. In at least one embodiment, context data for a user may also be stored to a user context data repository 122, which may include data about a user which may be useful as input to a network in generating inferences, or determining data to return to a user after obtaining instances. In at least one embodiment, relevant data, which may include at least some of input or inference data, may also be stored to a local database 134 for processing future requests. In at least one embodiment, a user can use account information or other information to access resources or functionality of a provider environment. In at least one embodiment, if permitted and available, user data may also be collected and used to further train models, in order to provide more accurate inferences for future requests. In at least one embodiment, requests may be received through a user interface to a machine learning application 126 executing on client device 102, and results displayed through a same interface. A client device can include resources such as a processor 128 and memory 562 for generating a request and processing results or a response, as well as at least one data storage element 512 for storing data for machine learning application 126.

In at least one embodiment a processor 128 (or a processor of training module 112 or inference module 118) will be a central processing unit (CPU). As mentioned, however, resources in such environments can utilize GPUs to process data for at least certain types of requests. With thousands of cores, GPUs, such as PPU that is designed to handle substantial parallel workloads and, therefore, have become popular in deep learning for training neural networks and generating predictions. While use of GPUs for offline builds has enabled faster training of larger and more complex models, generating predictions offline implies that either request-time input features cannot be used or predictions must be generated for all permutations of features and stored in a lookup table to serve real-time requests. If a deep learning framework supports a CPU-mode and a model is small and simple enough to perform a feed-forward on a CPU with a reasonable latency, then a service on a CPU instance could host a model. In this case, training can be done offline on a GPU and inference done in real-time on a CPU. If a CPU approach is not viable, then a service can run on a GPU instance. Because GPUs have different performance and cost characteristics than CPUs, however, running a service that offloads a runtime algorithm to a GPU can require it to be designed differently from a CPU based service.

In at least one embodiment, video data can be provided from client device 102 (e.g., edge device) for enhancement in provider environment 106. In at least one embodiment, video data can be processed for enhancement on client device 102. In at least one embodiment, video data may be streamed from a third party content provider 124 and enhanced by third party content provider 124, provider environment 106, or client device 102. In at least one embodiment, video data can be provided from client device 102 for use as training data in provider environment 106.

In at least one embodiment, supervised and/or unsupervised training can be performed by the client device 102 and/or the provider environment 106. In at least one embodiment, a set of training data 114 (e.g., classified or labeled data) is provided as input to function as training data. In an embodiment, the set of training data may be used in a generative adversarial training configuration to train a generator neural network, or any other type of configuration for training.

In at least one embodiment, training data can include images of at least one human subject, avatar, character, animal, object, or the like, for which a neural network is to be trained. In at least one embodiment, training data can include instances of at least one type of object for which a neural network is to be trained, as well as information that identifies that type of object. In at least one embodiment, training data might include a set of images that each includes a representation of a type of object, where each image also includes, or is associated with, a label, metadata, classification, or other piece of information identifying a type of object represented in a respective image. Various other types of data may be used as training data as well, as may include text data, audio data, video data, and so on. In at least one embodiment, training data 114 is provided as training input to a training module 112. In at least one embodiment, training module 112 can be a system or service that includes hardware and software, such as one or more computing devices executing a training application, for training a neural network (or other model or algorithm, etc.). In at least one embodiment, training module 112 receives an instruction or request indicating a type of model to be used for training, in at least one embodiment, a model can be any appropriate statistical model, network, or algorithm useful for such purposes, as may include an artificial neural network, deep learning algorithm, learning classifier, Bayesian network, and so on. In at least one embodiment, training module 112 can select an initial model, or other untrained model, from an appropriate repository 116 and utilize training data 114 to train a model, thereby generating a trained model (e.g., trained deep neural network) that can be used to classify similar types of data, or generate other such inferences. In at least one embodiment where training data is not used, an appropriate initial model can still be selected for training on input data per training module 112.

In at least one embodiment, a model can be trained in a number of different ways, as may depend in part upon a type of model selected. In at least one embodiment, a machine learning algorithm can be provided with a set of training data, where a model is a model artifact created by a training process. In at least one embodiment, each instance of training data contains a correct answer (e.g., classification), which can be referred to as a target or target attribute. In at least one embodiment, a learning algorithm finds patterns in training data that map input data attributes to a target, an answer to be predicted, and a machine learning model is output that captures these patterns. In at least one embodiment, a machine learning model can then be used to obtain predictions on new data for which a target is not specified.

In at least one embodiment, training and inference manager 132 can select from a set of machine learning models including binary classification, multiclass classification, generative, and regression models. In at least one embodiment, a type of model to be used can depend at least in part upon a type of target to be predicted.

Images generated applying one or more of the techniques disclosed herein may be displayed on a monitor or other display device. In some embodiments, the display device may be coupled directly to the system or processor generating or rendering the images. In other embodiments, the display device may be coupled indirectly to the system or processor such as via a network. Examples of such networks include the Internet, mobile telecommunications networks, a WIFI network, as well as any other wired and/or wireless networking system. When the display device is indirectly coupled, the images generated by the system or processor may be streamed over the network to the display device. Such streaming allows, for example, video games or other applications, which render images, to be executed on a server, a data center, or in a cloud-based computing environment and the rendered images to be transmitted and displayed on one or more user devices (such as a computer, video game console, smartphone, other mobile device, etc.) that are physically separate from the server or data center.

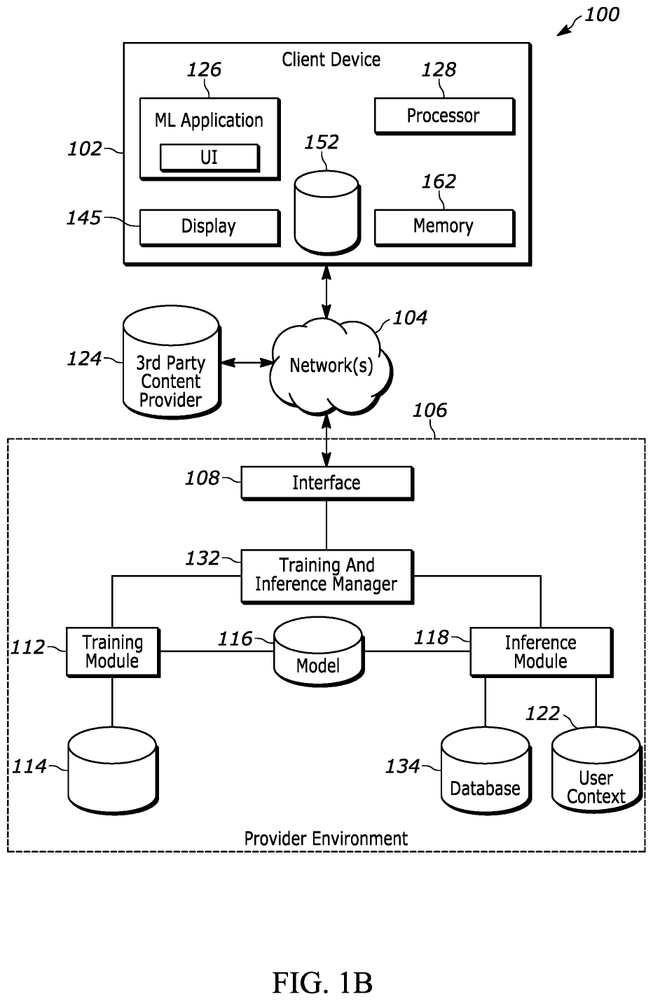

FIG. 2 is an embodiment of an edge-cloud system. In one embodiment, the edge device may include a data source 201, down sampling step 203, and audio video (AV) codec 205 transformation. The data source 201 may include data or information from a camera or any device (e.g., mobile phone, tablet, watch, tablet, etc.). The edge device may be any hardware that controls data flow at a boundary between networks. The edge device may provide an entry point into an enterprise or service provider core network. Thus, it may include routing capabilities, routing switches, integrated access devices (IADs), multiplexers, and a variety of metropolitan area network (MAN) and wide area network (WAN) access devices. Edge devices also provide connections into carrier and service provider networks. An edge device that connects a local area network to a high speed switch or backbone (such as an ATM switch) may be called an edge concentrator. Some non-limiting examples of the edge device include an in-car sensing device (e.g., lidar, radar, sonar, camera) that has a cloud application related to passenger safety through monitoring of activities, including suspicious activities around the vehicle. A video surveillance camera is another example that may utilize cloud-based monitoring of retail stares and for forensic search applications. In yet another embodiment, a smart phone may be an edge device that is utilizing efficient storage and retrieval of photo and video albums via the cloud application. In yet another example, a dash cam may be an edge device utilizes for an accurate evidence of potential insurance claims.

The edge device may include any combination of a personal digital assistant (PDA) and a mobile telephone, an integrated messaging device (IMD), a desktop computer, a notebook computer. The edge device may be stationary or mobile when carried by an individual who is moving. The edge device may also be located in a mode of transport including, but not limited to, a car, a truck, a taxi, a bus, a train, a boat, an airplane, a bicycle, a motorcycle or any similar suitable mode of transport.

At block 203, down sampling may take place of the data, which may include video data or image data. The down sampling may receive a depth sequence of the data and reduce its resolution. In one example, the system may have an original video or picture taken via a camera at a high resolution (e.g., greater than 300 dpi) and down sample to a lower resolution (e.g., 72 dpi). Downsampling or sub sampling process may be defined as reducing the sampling rate of a signal, and it typically results in reducing of the image sizes in horizontal and/or vertical directions. In image downsampling, the spatial resolution of the output image, e.g., the number of pixels in the output image, is reduced compared to the spatial resolution of the input image. Downsampling ratio may be defined as the horizontal or vertical resolution of the downsampled image divided by the respective resolution of the input image for downsampling. Downsampling ratio may alternatively be defined as the number of samples in the downsampled image divided by the number of samples in the input image for downsampling. As the two definitions differ, the term downsampling ratio may further be characterized by indicating whether it is indicated along one coordinate axis or both coordinate axes (and hence as a ratio of number of pixels in the images). Image downsampling may be performed for example by decimation, e.g., by selecting a specific number of pixels, based on the downsampling ratio, out of the total number of pixels in the original image. In some embodiments downsampling may include low-pass filtering or other filtering operations, which may be performed before or after image decimation. Any low-pass filtering method may be used, including but not limited to linear averaging.

At block 205, the AV codec may be a device, program, or module that encodes or decodes the data stream or signal. In the edge device, this may be the down sampled data. A coder or encoder encodes a data stream or a signal for transmission or storage, possibly in encrypted form, and the decoder function reverses the encoding for playback or editing. Thus, the AV codec at the edge device may encode a lower resolution image that may later be decoded at the cloud (e.g., remote work) or another device).

In typical codecs the motion information may be indicated with motion vectors associated with each motion compensated image block, such as a prediction unit. Each of these motion vectors represents the displacement of the image block in the picture to be coded (in the encoder side) or decoded (in the decoder side) and the prediction source block in one of the previously coded or decoded pictures. In order to represent motion vectors efficiently, the motion vectors may be typically coded differentially with respect to block specific predicted motion vectors. In typical video codecs the predicted motion vectors may be created in a predefined way, for example calculating the median of the encoded or decoded motion vectors of the adjacent blocks. Another way to create motion vector predictions is to generate a list of candidate predictions from adjacent blocks and/or co-located blocks in temporal reference pictures and signaling the chosen candidate as the motion vector predictor. In addition to predicting the motion vector values, it can be predicted which reference picture(s) are used for motion-compensated prediction and this prediction information may be represented for example by a reference index of previously coded/decoded picture. The reference index may be predicted from adjacent blocks and/or co-located blocks in temporal reference picture. Moreover, typical high efficiency video codecs employ an additional motion information coding/decoding mechanism, often called merging/merge mode, where all the motion field information, which includes motion vector and corresponding reference picture index for each available reference picture list, may be predicted and used without any modification/correction. Similarly, predicting the motion field information is carried out using the motion field information of adjacent blocks and/or co-located blocks in temporal reference pictures and the used motion field information is signaled among a list of motion field candidate list filled with motion field information of available adjacent/co-located blocks.

Typical video codecs enable the use of uni-prediction, where a single prediction block is used for a block being (de)coded, and bi-prediction, where two prediction blocks are combined to form the prediction for a block being (de)coded. Some video codecs enable weighted prediction, where the sample values of the prediction blocks are weighted prior to adding residual information. For example, multiplicative weighting factor and an additive offset which can be applied. In explicit weighted prediction, enabled by some video codecs, a weighting factor and offset may be coded for example in the slice header for each allowable reference picture index. In implicit weighted prediction, enabled by some video codecs, the weighting factors and/or offsets are not coded but are derived e.g. based on the relative picture order count (POC) distances of the reference pictures. In typical video codecs the prediction residual after motion compensation may be first transformed with a transform kernel (like DCT) and then coded. There may exist some correlation among the residual and transform can in many cases help reduce this correlation and provide more efficient coding.

At block 207, the edge device may send the encoded lower resolution image to the cloud. This may be conducted via either a wireless transmission or a wired transmission. For example, a wireless transceiver of the edge device may send a wireless signal including the encoder low resolution image or data to the cloud. The wireless transceiver may send via any combination of wired or wireless networks including, but not limited to a wireless cellular telephone network (such as a GSM, UMTS, CDMA network etc), a wireless local area network (WLAN) such as defined by any of the IEEE 802.x standards, a Bluetooth personal area network, an Ethernet local area network, a token ring local area network, a wide area network, and the Internet. The edge device may further comprise an infrared port for short range line of sight communication to other devices. In other embodiments the edge device may further comprise any suitable short range communication solution such as for example a Bluetooth wireless connection or a USB/firewire wired connection.

At block 209, the AV codec may receive the encoded lower resolution image from the edge device at the cloud. A corresponding codec may then be utilized to decode the lower resolution image to an analog form using an AV decoder for playback. The codec may thus utilize the file or data that was transmitted wirelessly. The video footage may be decoded utilizing a video codec and the associated sound may be decoded via an audio codec.

At block 211, the cloud network may reconstruct the data. Such reconstruction may be done via a number of processes, including bi-cubic interpolation. In one embodiment, such upscaling techniques may determine values for the additional pixels required to create a higher resolution image by averaging neighboring pixels. This may create a blurring effect or other visual artefacts such as “ringing” artefacts. Most upscaling techniques use interpolation-based techniques to produce higher-resolution versions of received video data. Various methods of interpolation may be used in relation to video or image enhancement.

At block 213, one or more applications at the cloud network may utilize the reconstruction data. Thus, the reconstructed image may be output via a display device, such as a monitor, television, mobile device, tablet, or any type of display. Some non-limiting examples of the edge device include an in-car sensing device (e.g., lidar, radar, sonar, camera) that has a cloud application related to passenger safety through monitoring of activities, including suspicious activities around the vehicle. A video surveillance camera is another example that may utilize cloud-based monitoring of retail stares and for forensic search applications. In yet another embodiment, a smart phone may be an edge device that is utilizing efficient storage and retrieval of photo and video albums via the cloud application. In yet another example, a dash cam may be an edge device utilizes for an accurate evidence of potential insurance claims.

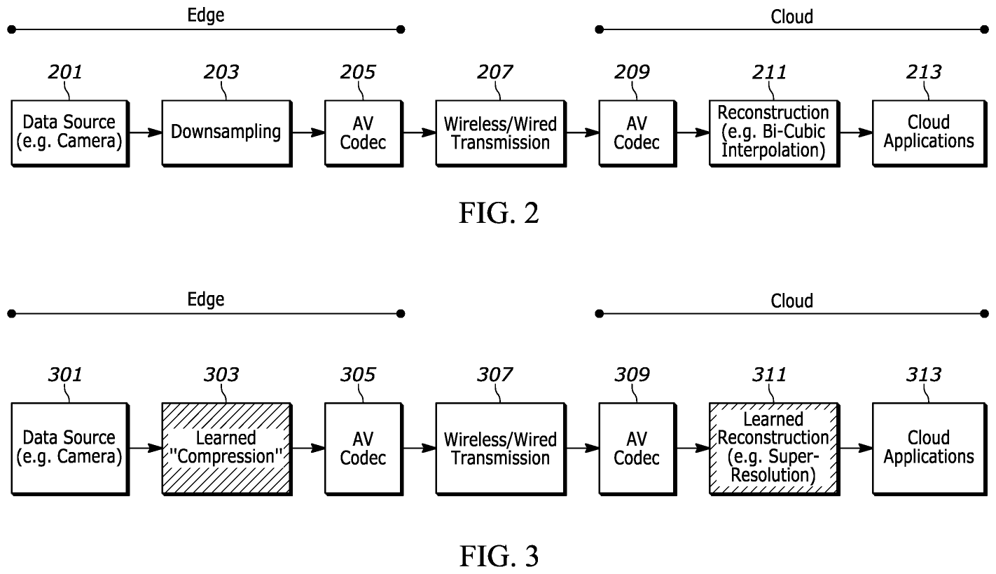

FIG. 3 illustrates an embodiment of edge-cloud system that may utilized one embodiment of compression. In one embodiment, the edge device may include a data source 301, “learned compression” block 303, and audio video (AV) codec 305 transformation. The data source 301 may include data or information from a camera or any device (e.g., mobile phone, tablet, watch, tablet, etc.). The edge device may be any hardware that controls data flow at a boundary between networks. The edge device may provide an entry point into an enterprise or service provider core network. Thus, it may include routing capabilities, routing switches, integrated access devices (IADs), multiplexers, and a variety of metropolitan area network (MAN) and wide area network (WAN) access devices. Edge devices also provide connections into carrier and service provider networks. An edge device that connects a local area network to a high speed switch or backbone (such as an ATM switch) may be called an edge concentrator. Some non-limiting examples of the edge device include an in-car sensing device (e.g., lidar, radar, sonar, camera) that has a cloud application related to passenger safety through monitoring of activities, including suspicious activities around the vehicle. A video surveillance camera is another example that may utilize cloud-based monitoring of retail stares and for forensic search applications. In yet another embodiment, a smart phone may be an edge device that is utilizing efficient storage and retrieval of photo and video albums via the cloud application. In yet another example, a dash cam may be an edge device utilizes for an accurate evidence of potential insurance claims.

The edge device may include any combination of a personal digital assistant (PDA) and a mobile telephone, an integrated messaging device (IMD), a desktop computer, a notebook computer. The edge device may be stationary or mobile when carried by an individual who is moving. The edge device may also be located in a mode of transport including, but not limited to, a car, a truck, a taxi, a bus, a train, a boat, an airplane, a bicycle, a motorcycle or any similar suitable mode of transport.

At block 303, a “learned compression” may be utilized. With respect to the tpical application, the “learned compression” model 303 may be utilized rather than a tradition downsampling. This may include a training method to jointly learn the compression model (at the edge) along with the super-resolution (SR) model (at the cloud).

At block 305, the AV codec may be a device, program, or module that encodes or decodes the data stream or signal. In the edge device, this may be the down sampled data. A coder or encoder encodes a data stream or a signal for transmission or storage, possibly in encrypted form, and the decoder function reverses the encoding for playback or editing. Thus, the AV codec at the edge device may encode a lower resolution image that may later be decoded at the cloud (e.g., remote work) or another device).

At block 307, the edge device may send the encoded lower resolution image to the cloud. This may be conducted via either a wireless transmission or a wired transmission. For example, a wireless transceiver of the edge device may send a wireless signal including the encoder low resolution image or data to the cloud. The wireless transceiver may send via any combination of wired or wireless networks including, but not limited to a wireless cellular telephone network (such as a GSM, UMTS, CDMA network etc), a wireless local area network (WLAN) such as defined by any of the IEEE 802.x standards, a Bluetooth personal area network, an Ethernet local area network, a token ring local area network, a wide area network, and the Internet. The edge device may further comprise an infrared port for short range line of sight communication to other devices. In other embodiments the edge device may further comprise any suitable short range communication solution such as for example a Bluetooth wireless connection or a USB/fire wire wired connection.

At block 309, the system may utilize an AV codec at the cloud to decode. The AV codec may be a device, program, or module that decodes the data stream, images, video, or signals. In the cloud device, this may be the down sampled data. While a coder or encoder encodes a data stream or a signal for transmission or storage, possibly in encrypted form, and the decoder function reverses the encoding for playback or editing. Thus, the AV codec may receive the encoded lower resolution image from the edge device at the cloud. A corresponding codec may then be utilized to decode the lower resolution image to an analog form using an AV decoder for playback. The codec may thus utilize the file or data that was transmitted wirelessly. The video footage may be decoded utilizing a video codec and the associated sound may be decoded via an audio codec

At block 311, the system may utilize a learned reconstruction to create a final image. The learned reconstruction may utilize super resolution via deep learning. Super resolution may be the process of recovering a High Resolution (HR) image from a given Low Resolution (LR) image. An image may have a “lower resolution” due to a smaller spatial resolution (i.e. size) or due to a result of degradation (such as blurring). A super resolution imaging may generate a high resolution (HR) image from a low resolution (LR) image. Super resolution (SR) imaging may have wide applicability, from surveillance and face/iris recognition to medical image processing, as well as the straightforward improvement of the resolution of images and video. Sometimes referred to as “SRCNNs” (i.e., super-resolution convolutional neural networks), their accuracy can be limited by a small structure, e.g., 3-layers, and/or small context reception field. In response, researchers have proposed increasing the size of SRCNNs, but most proposals use a prohibitively large number of parameters, and many of the SRCNNs under discussion cannot be executed in real-time. Due to the large network sizes being proposed, it can be very difficult to even guess at the appropriate training settings, i.e., learning rate, weight initialization, and weight decay. As a result, training may not converge at all or fall into a local minimum. Deep learning based super resolution models may be trained using Generative Adversarial Networks (GANs).

At block 313, the cloud application may be utilized to receive the final images. The cloud application may include software to output the final image that is reconstructed. Thus, the final output may have an image that is a lower size than the typical HR image. However, the final image that is output may be a better resolution image than the encoded LR image, with a comparable data size or only slight larger in data size. In another application, the cloud may send the image to another device or client to output that includes the same resolution as that of the reconstructed HR image.

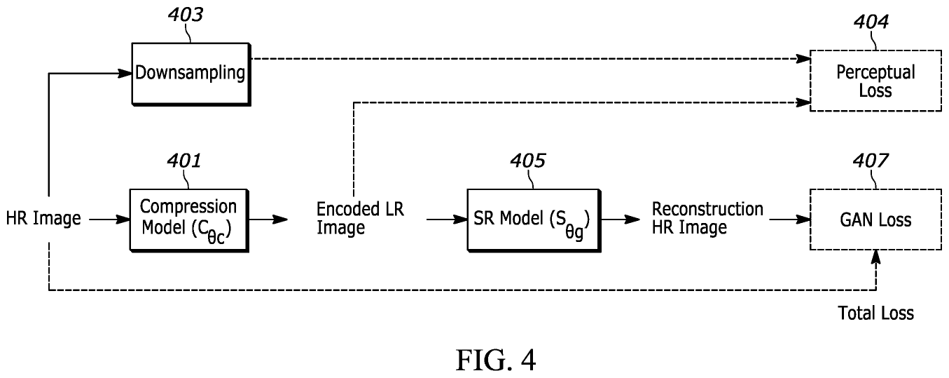

FIG. 4 illustrates an embodiment of a flow chart or diagram for a training phase of the compression model. The high resolution image (HR image or HRI) may be sent to both a compression model 401 or a downsampling model 403. The compression model 401 may output a encoded low resolution image (LR image or LRI). The low resolution image may be lower in resolution than the HRI. Once stablished, the encoded LR image may be utilized to determine a perceptual loss 407 as compared to the down sampling version of the HR image. The training phase may be utilized during both the “learned compression” block and the “learned reconstruction” block shown in FIG. 3 above.

The encoded LR image may then be sent to the super resolution (SR) model. The SR model may utilize the encoded LR image to enhance the quality of the LR image. Thus, the super resolution imaging may generate a high resolution (HR) image from a low resolution (LR) image. Super resolution (SR) imaging may have wide applicability, from surveillance and face/iris recognition to medical image processing, as well as the straightforward improvement of the resolution of images and video.

The modified training phase is shown in FIG. 4 where the system may concatenate both the compression and the SR model and derive a common loss function. This proposed loss function, on one hand, ensures high fidelity reconstruction (GAN loss) of the original image and, on the other hand, ensures that the low quality encoded image is “close enough” to the down-sampled image (perceptual loss). The perceptual loss is critical to make use of the AV codec that further encodes the images for efficient transmission in case of video data. Since the compression model (usually neural network) runs at the edge, it is usually composed of quantized convolutional layers which leads to a mixed-precision training or quantization aware training. The SR model may output the reconstruction HR image.

The results with the proposed approach utilizing compared with the traditional system is provided in the following table:

TABLE 2

| Scale | SRGAN | | BiCubic Intp. | |
|---|---|---|---|---|
| factor | Average PSNR | Average SSIM | Average PSNR | Average SSIM |
| 2× | 31.263 | 0.947 | 26.988 | 0.882 |
| 4× | 26.661 | 0.836 | 23.028 | 0.730 |
| 8× | 21.560 | 0.617 | 19.340 | 0.508 |
| 16× | 18.610 | 0.445 | 16.829 | 0.385 |

In the end, the process may lower bandwidth for video and image data transmissions. There may be better quality of data reconstruction at the cloud for a given bandwidth as well. Last, certain types of processor kernels (e.g., multiply-accumulate MAC) usages at the edge before image/video data may get transmitted.

Implementations of the various processes and features described herein may be embodied in a variety of different equipment or applications, particularly, for example, equipment or applications associated with data encoding, data decoding, view generation, depth processing, and other processing of images and related depth and/or disparity maps. Examples of such equipment include an encoder, a decoder, a post-processor processing output from a decoder, a pre-processor providing input to an encoder, a video coder, a video decoder, a video codec, a web server, a set-top box, a laptop, a personal computer, a cell phone, a PDA, and other communication devices. As should be clear, the equipment may be mobile and even installed in a mobile vehicle.

While exemplary embodiments are described above, it is not intended that these embodiments describe all possible forms encompassed by the claims. The words used in the specification are words of description rather than limitation, and it is understood that various changes can be made without departing from the spirit and scope of the disclosure. As previously described, the features of various embodiments can be combined to form further embodiments of the invention that may not be explicitly described or illustrated. While various embodiments could have been described as providing advantages or being preferred over other embodiments or prior art implementations with respect to one or more desired characteristics, those of ordinary skill in the art recognize that one or more features or characteristics can be compromised to achieve desired overall system attributes, which depend on the specific application and implementation. These attributes can include, but are not limited to cost, strength, durability, life cycle cost, marketability, appearance, packaging, size, serviceability, weight, manufacturability, ease of assembly, etc. As such, to the extent any embodiments are described as less desirable than other embodiments or prior art implementations with respect to one or more characteristics, these embodiments are not outside the scope of the disclosure and can be desirable for particular applications.

What is claimed is:

1. A system, comprising:
a wireless transceiver, wherein the wireless transceiver is configured to communicate with a remote network;
a camera, wherein the camera is configured to capture images or video recordings
a controller, wherein the controller is configured to:
receive one or more images from the camera, wherein the one or more images from the camera is a high resolution image;
downsample the high resolution image (HRI);
compress the HRI via a compression model at an edge device, wherein the HRI is compressed to a low resolution image (LRI);
encode the LRI and send an encoded LRI to a super resolution model at the remote network;
decode the encoded LRI at the remote network to obtain a reconstructed HRI; and
output the reconstructed HRI.

2. The system of claim 1, wherein the downsampling and compressing the HRI are executed in parallel paths.

3. The system of claim 1, wherein the super resolution model is configured to be trained utilizing a Generative Adversarial Networks.

4. The system of claim 1, wherein in response to the downsampling of the HRI, the controller is configured to identify a perceptual loss comparing the HRI and a compressed HRI.

5. The system of claim 1, wherein in response to compressing the HRI, the controller is configured to identify a perceptual loss comparing the HRI and the low resolution image.

6. The system of claim 1, wherein the super resolution model is configured to be trained.

7. An apparatus, comprising:
a wireless transceiver, wherein the wireless transceiver is configured to communicate with a remote network;
a camera, wherein the camera is configured to capture images or video recordings;
a controller, wherein the controller is in communication with the wireless transceiver and the camera, wherein the controller is configured to:
receive one or more images from the camera, wherein the one or more images from the camera is a high resolution image (HRI);
compress the HRI via a compression model to a low resolution image (LRI);
encode the LRI and send an encoded LRI to a super resolution model at the remote network, wherein the super resolution model utilizes a machine learning network;
send the encoded LRI to a remote network configured to decode the encoded LRI at the remote network to obtain a reconstructed HRI.

8. The apparatus of claim 7, wherein the controller is further configured to downsample the high resolution image (HRI) concurrently with compressing the HRI.

9. The apparatus of claim 7, wherein the controller is further configured to identify a perceptual loss associated with the LRI compared to the encoded LRI.

10. The apparatus of claim 7, wherein the super resolution model is configured to be trained utilizing at least a perceptual loss.

11. The apparatus of claim 7, wherein the super resolution model is configured to be trained via utilizing a perceptual loss and a Generative Adversarial Network (GAN) loss.

12. The apparatus of claim 7, wherein the controller is configured to utilize multiply-accumulate operations prior to the images be transmitted.

13. The apparatus of claim 7, wherein the one or more images includes thermal, radar, LiDar, sound, sonar, ultrasonic, or image.

14. A computer-implemented method, comprising:
communicating with a remote network;
capturing one or more images or video recordings;
receiving one or more images from the camera, wherein the one or more images from the camera is a high resolution image (HRI);
compressing the HRI via a compression model to a low resolution image (LRI);
encoding the LRT to obtain an encoded LRT;
sending the encoded LRT to a super resolution model at the remote network;
decoding the encoded LRT at the remote network to obtain a reconstructed HRI; and
outputting the reconstructed HRI.

15. The method of claim 14, wherein the reconstructed HRI is a higher quality than the low resolution image.

16. The method of claim 14, wherein encoding the LRI is accomplished utilizing a compression model configured to train at an edge device.

17. The method of claim 14, wherein the compression model and the super resolution model are jointly trained.

18. The method of claim 17, wherein the compression model is trained at an edge device and the super resolution model is trained at the remote network.

19. The method of claim 14, wherein the compression model utilizes a neural network.

20. The method of claim 14, wherein the reconstructed HRI is output at the remote network via an application.
